(19) United States
(12) Patent Application Publication
(10) Pub. No.: US 2005/0082069 A1
(43) Pub. Date: Apr. 21, 2005

(54) Weedevader

(76) Inventor: Warren Charles Bodeker, Plains, MT (US)

Correspondence Address: WARREN CHARLES BODEKER, 8594 HIWAY 200, PLAINS, MT, 59859, US

(21) Appl. No.: 10/691,018

(22) Filed: Oct. 21, 2003

(51) Int. Cl. A01D 15/00

(52) U.S. Cl. 172/13

(57) ABSTRACT

This weeding tool, consisting basically of a thin flat steel disk attached to and rotated by various battery, electric, or gas driven motors. The disk has short lugs protruding downward on the underside. The purpose of the lugs is to invade the surface of the soil as the disk rotates, thereby, eliminating any weed growth and at the same time cultivating and aerating the soil to the depth of the lugs. To dig deeper, the operator must apply a downward pressure on the disk. The disk, rotating horizontally, parallel to the ground, does not have a tendency to dig deeper into the soil without downward pressure, but does have a tendency to float over the surface with minimal operator effort. With shallow soil invasion, buried weed seeds will not be brought to the soil surface and into the light where they can sprout and grow, thereby, robbing plants of minerals and water. Used in the standing position, the weeder eliminates most stooping, kneeling, and misery associated with weeding a garden by hand. Further, a rotating-disk weeder operator is able to weed and aerate an entire average sized garden in the time it takes to weed one row by hand.

### CROSS-REFERENCE TO RELATED APPLICATIONS

(NOT APPLICABLE)

### STATEMENT REGARDING FEDERALLY SPONSORED RESEARCH OR DEVELOPMENT

(NOT APPLICABLE)

### REFFERENCE TO SEQUENCE LISTING, A TABLE, OR A COMPUTER PROGRAM LISTING COMPACT DISK APPENDIX

(NOT APPLICABLE)

### BACKGROUND OF THE INVENTION

It is generally the assumption that all garden weeding must include bending over, kneeling, backache, and pain. Thus the consistent goal of mankind has been to invent tools to eliminate hard work and pain. Much has been achieved in many fields of labor, yet we are still in the Stone Age when it involves gardening or landscaping. Now, at last, there is a tool (a soil invading disk) that attaches to power-driven implements so you can standup and weed most areas around the house and garden. This new tool provides shallow soil invasion in very close to plants eliminating most weeds. The design of the tool is basically a flat disk that rotates parallel with the ground and has protruding lugs that invade the soil. When attached to a power-driven implement this tool eliminates most bending and kneeling while weeding. The goal of this invention is to keep a garden almost weed free, stop the pain and labor currently associated with gardening, control the depth of soil invasion, have a minimum of soil and plant disturbance, conserve water and minerals, encourage the use of battery powered implements to reduce air and noise pollution, and to open gardening to the elderly and infirm.

### BRIEF SUMMARY OF THE INVENTION

The subject invention is a disk-shaped tool for garden weeding. This tool may be attached to various existing power-driven implements or to its own custom-designed implements (not part of this invention).

### BRIEF DESCRIPTION OF THE SEVERAL VIEWS OF THE DRAWING

FIG. 1 is a top view of the disk. Line 10 is the disk. Line 16 is the center hole for attaching disk to power-driven implement. Line 20 is the open hole left when lugs are punched out to protrude on the underside of the disk.

FIG. 2 is a side view of the disk. Line 10 is the disk. Line 14 is the protruding lugs. Line 18 is the alternate shaft for attaching the disk to a power-driven implement.

FIG. 3 is another view of the disk showing the lugs Line 14.

### DETAILED DESCRIPTION OF THE INVENTION

The invention consists of a round thin flat piece of metal, referred to as the disk, which may be punch-pressed, disk, lugs, and mounting hole complete in a single operation. Being flat, thin and round, the disk has a tendency to float on the surface of the soil. By installing lugs on one side of the disk to protrude into the ground and invade or dig in the soil surface as the disk rotates parallel to the ground. The disk tool only digs to the depth of the lug length. The disk may be of various diameter and lugs of various length and shape, depending on the weeding/aerating situation. Standard lug length is 1⅛ inch long for shallow soil penetration. Alternate mounting shaft, Line 18 (FIGS. 2 and 3) will vary according to the different mounting requirements of the various manufactures of power implements (not part of this invention).

This weedevader disk brings garden weeding out of the Dark Ages of hand weeding and rototilling into the 21^{st} Century by letting the power implements evade most garden weeding and replacing most garden weeding hand tools.

OLD INVENTIONS: Various styles of hoes which cut weeds off (very laborious).
Rototillers—rototilling buries seed on soil surface into the ground to come up in later years and digs up seeds buried in the ground from prior rototilling; a never ending process.

This weedevader disk is designed to use various power implements to prevent weeds from getting established in gardens and landscapes by using before planting and after plants have started to grow. It invades garden soil by the lugs on the underside of the disk. The disk floats on the soil surface. Soil penetration is limited by the length of the lugs and will not bring weed seed to the surface or light to sprout and grow and will eliminate new growth of weeds if used on a regular basis.

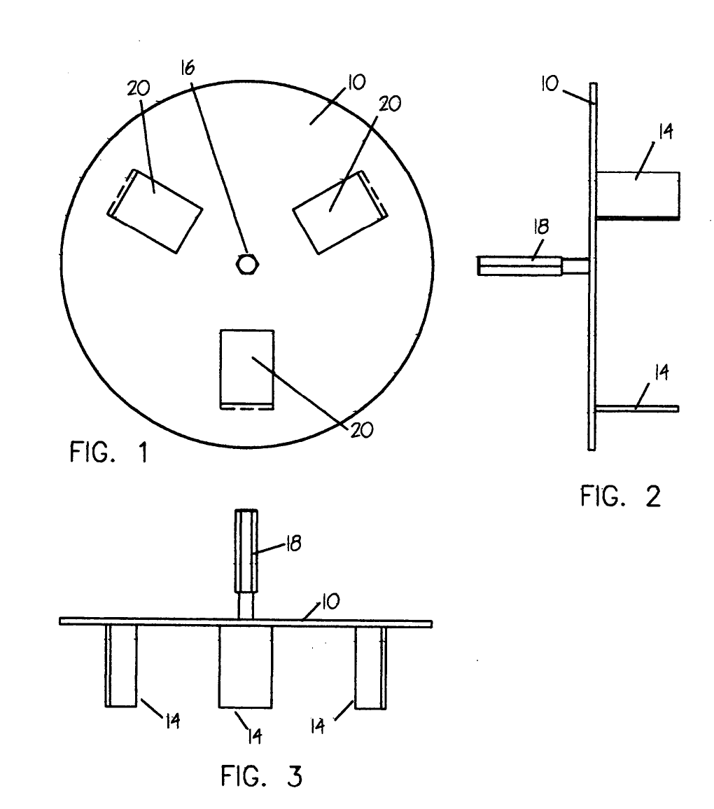

1. The invention of this shallow soil invading disk (see FIGS. 1, 2 and 3) with protruding lugs on the underside, which is designed to rotate horizontally and allows the operator to weed in close, very close to plants.

2. This soil invading disk that only penetrates the soil to the depth of the attached lugs. (FIGS. 2 and 3, line 14) Lugs may be from ½-inch long to any practical length as needed. The standard lug length is 1⅛-inch long.

3. This soil invading disk can be adapted to fit various power driven tools (not shown). Attachment is by a center hole (FIG. 1, line 16) or by a protruding shaft (FIGS. 2 and 3, line 18). Power driven machines are not part of this invention.

4. This soil invading disk removes weeds close to plants and all weeds between plants, which are spaced a little more than the diameter of the soil invading disk.

5. Weeding is done from a standing position with the soil invader disk attached to a power driven machine such as a weed eater (not part of this invention).

6. This soil invading disk will totally weed most gardens on a single charge of the 12-volt battery (not part of this invention), thereby, saving on fuel and reducing pollution of the environment.

7. This soil invading disk works the soil at a shallow depth without destroying worms or the soil tilth.

8. This soil invading disk can be easily made using a punch press. The disk (FIG. 1, Line 10), lugs (FIGS. 2 and 3, Line 14), and center hole (FIG. 1, Line 16) all done in one operation.

9. This soil invading disk can be made in various diameters to suite the needs of the weeding operation. Orchard weeding will usually need a large diameter disk; whereas, weeding in the garden and around the house will need a small diameter disk.

10. Weeding around the house, under plants, foliage, and bushes may require a small power driven one handed implement (not part of this invention) with a 2½-inch diameter or larger soil invading disk attached.

11. This soil invading disk will quickly mix fertilizers and soil adamants into the top soil next to plants.

12. This soil invading disk will dig shallow trenches for planting.
